(19) United States
(12) Patent Application Publication
(10) Pub. No.: US 2025/0196221 A1
(43) Pub. Date: Jun. 19, 2025

(54) DISPENSING DEVICE FOR INTERMITTENTLY DISPENSING A COOLING MEDIUM ONTO A CAST STRAND

(71) Applicant: Primetals Technologies Austria GmbH, Linz (AT)

(72) Inventors: Andreas MITTERMAIR, Linz (AT); Johann POEPPL, Kirchschlag (AT); Thomas STEPANEK, Wien (AT); Philipp WIESER, Schiedlberg (AT)

(21) Appl. No.: 18/846,618

(22) PCT Filed: Mar. 9, 2023
(86) PCT No.: PCT/EP2023/056046

§ 371 Date: Sep. 12, 2024

(30) Foreign Application Priority Data
Mar. 14, 2022 (AT) A50160/2022

(51) Int. Cl. B22D 11/124; B05B 1/08; B05B 1/30; B22D 11/22

(52) U.S. Cl. CPC B22D 11/1246; B05B 1/083; B05B 1/306; B22D 11/22

(57) ABSTRACT

A dispensing device that intermittently dispenses a cooling medium onto a cast strand in a continuous casting installation. The dispensing device has a housing with at least one inlet opening for letting the cooling medium into the housing and a dispensing opening for dispensing the cooling medium out of the housing. A switching valve is arranged in the housing and is designed to open and close the dispensing opening. The switching valve has a sleeve, which is filled with a working fluid and which, on the dispensing opening side, is closed with a closure in a fluid-tight manner. The closure has a switching element, which, by controlling the pressure in the working fluid, is displaceable relative to the sleeve into a closing position in which the switching element closes the dispensing opening.

### CROSS-REFERENCE TO RELATED APPLICATIONS

The present application is a 35 U.S.C. §§ 371 national stage application of International Application No. PCT/EP2023/056046, filed Mar. 9, 2023, which claims priority to Austrian Patent Application A50160/2022, filed Mar. 14, 2022, the contents of which are incorporated herein by reference.

### FIELD OF INVENTION

The invention relates to a dispensing device for intermittently dispensing a cooling medium onto a cast strand in a continuous casting installation.

### BACKGROUND

In a continuous casting installation, a metallic melt from a casting ladle is cast by a cooled permanent mold in which the solidification of the melt starts. Surface regions of the melt solidify so as to form a strand shell within the permanent mold, said strand shell enclosing a metal core which is mostly still liquid. The at least partially solidified metallic cast strand is dispensed from the permanent mold to a strand guide that conveys the cast strand away.

The cast strand is further cooled in the strand guide. For this purpose, a cooling medium is dispensed onto the cast strand. A cooling liquid, typically water (so-called “water only” cooling), or a mixture of a liquid and a gas (so-called “air mist” cooling) is used as a cooling medium, for example.

WO 2018/224304 A1 discloses a coolant nozzle for cooling a metallic strand in a continuous casting installation. The coolant nozzle has a mouthpiece which is disposed on a nozzle exit end and through which liquid coolant can exit the coolant nozzle. In order to enable a rapid build-up of pressure at the coolant nozzle, the latter provides a supply which is designed as a tube-in-tube system, is disposed in front of the mouthpiece in the flow direction, and has a supply exit end, control air being able to be delivered to the supply exit end by way of the first tube of said coolant nozzle, and the coolant being able to be supplied to the mouthpiece by way of the second tube of said coolant nozzle. Furthermore, the coolant nozzle has a switching valve for controlling the supply of the liquid coolant into the mouthpiece, said switching valve being integrated into the supply and being pneumatically activatable while using the control air. In one configuration of the switching valve as a seat valve, the switching element comprises a control piston and a corrugated bellows which guides, and optionally seals, the control piston in relation to the supply.

### SUMMARY OF THE INVENTION

The invention is based on the object of specifying an improved device for dispensing a cooling medium onto a cast strand in a continuous casting installation.

The object is achieved according to the invention by a dispensing device having the claimed features, and by a cooling installation having the claimed.

Advantageous design embodiments of the invention are the subject matter of the dependent claims.

A dispensing device according to the invention for intermittently dispensing a cooling medium onto a cast strand in a continuous casting installation comprises a housing having at least one inlet opening for admitting the cooling medium into the housing, and a dispensing opening for dispensing the cooling medium from the housing, and a switching valve which is disposed in the housing and is specified to open and close the dispensing opening. The switching valve has a sleeve which is filled with a working fluid and proximal to the dispensing opening is closed in a fluid-tight manner by a closure.

In a first embodiment of a dispensing device according to the invention, the closure comprises a switching element and an elastic sealing element which is fixedly connected to the sleeve and to the switching element and couples the switching element to the sleeve in a movable and fluid-tight manner. The switching element, by controlling a pressure in the working fluid, is displaceable relative to the sleeve to a closing position in which the switching element closes the dispensing opening. The sealing element is preferably made of an elastomer material, for example of a silicone or a rubber.

A dispensing device according to the invention enables its dispensing opening to be closed and opened by moving the switching element of the switching valve in a pressure-controlled manner. The pressure in the working fluid is increased for closing the dispensing opening, so that the switching element is displaced to the dispensing opening and the dispensing opening is closed by the switching element. The pressure in the working fluid is reduced for opening the dispensing opening, so that the switching element is displaced in the direction of the sleeve by the pressure in the working fluid, as a result of which the dispensing opening is opened. In this way, the dispensing of the cooling medium can be controlled by the dispensing device by means of the pressure in the working fluid.

The closure of the sleeve of the switching valve prevents that cooling medium can enter the sleeve, or working fluid can exit the sleeve. In the first embodiment of a dispensing device according to the invention, the closure has an elastic sealing element. The switching element is movably coupled to the sleeve by the sealing element.

In one design embodiment of the first embodiment of a dispensing device according to the invention, the sealing element is a rolling bellows which has a first collar connected to an inner surface of the sleeve, and a second collar connected to the switching element. For example, the rolling bellows has a rolling fold which runs between the first collar and the second collar. For guiding the switching element, the sleeve can have a bar-type guiding element which runs along the longitudinal axis of said sleeve and protrudes into a cutout in the switching element that corresponds to the guiding element. The rolling bellows seals an intermediate space between the switching element and the sleeve in a fluid-tight manner. The guiding element enables mechanical guiding of the switching element in such a way that no tilting of the switching element occurs in the movements of the latter.

In an alternative design embodiment of the first embodiment of a dispensing device according to the invention, the sealing element is a diaphragm which closes the sleeve and on which the switching element is disposed proximal to the dispensing opening. In this case, the diaphragm seals the sleeve in a fluid-tight manner and simultaneously serves for guiding the switching element disposed on said diaphragm.

In a second embodiment of a dispensing device according to the invention, the closure comprises a switching element which is movably mounted in the sleeve, and at least one sliding sealing element, for example an annular seal, which is disposed on the switching element or the sleeve and seals an intermediate space between the sleeve and the switching element. The switching element, by controlling a pressure in the working fluid, is again displaceable relative to the sleeve to a closing position in which the switching element closes the dispensing opening.

In the second embodiment of a dispensing device according to the invention, the switching element is guided by the sleeve of the switching valve. In order to seal the sleeve, at least one sliding sealing element, for example an annular seal, is disposed on the switching element or the sleeve.

In the second embodiment of a dispensing device according to the invention, for guiding the switching element, the sleeve can also furthermore have a bar-type guiding element which runs along the longitudinal axis of said sleeve and protrudes into a cutout in the switching element that corresponds to the guiding element.

A dispensing device according to the invention can have a nozzle to which the cooling medium to be dispensed is able to be supplied from the dispensing opening. A jet of the cooling medium to be dispensed by the dispensing device can be shaped by the nozzle.

The housing and the sleeve of a dispensing device according to the invention are disposed so as to be concentric, for example. This enables in particular a uniform flow of the cooling medium along the sleeve.

The working fluid of a dispensing device according to the invention is a gas, in particular air, for example. Alternatively, the working fluid is a liquid, for example an oil.

A dispensing device according to the invention can contain a spring element which moves the switching element from the closing position to an opening position. The spring element pushes the switching element to the opening position when no pressure is exerted on the switching element by the working fluid.

A cooling installation according to the invention for cooling a cast strand in a continuous casting installation has a plurality of dispensing devices according to the invention for intermittently dispensing a cooling medium onto the cast strand. Furthermore, the cooling installation can have a control unit which is specified for controlling the pressure in the working fluid in the dispensing devices.

### BRIEF DESCRIPTION OF THE FIGURES

The properties, features and advantages of this invention described above, and the manner in which these are achieved, will become more clearly and distinctively comprehensible in the context of the following description of exemplary embodiments which are explained in more detail in the context of the drawings. In the drawings:

FIG. 1 shows a schematic illustration of a continuous casting installation;

FIG. 2 shows a sectional illustration of a first exemplary embodiment of a dispensing device for intermittently dispensing a cooling medium onto a cast strand;

FIG. 3 shows a perspective illustration of the switching valve of a second exemplary embodiment of a dispensing device for intermittently dispensing a cooling medium onto a cast strand;

FIG. 4 shows a perspective illustration of the switching valve of a third exemplary embodiment of a dispensing device for intermittently dispensing a cooling medium onto a cast strand; and

FIG. 5 shows a perspective illustration of the switching valve of a fourth exemplary embodiment of a dispensing device for intermittently dispensing a cooling medium onto a cast strand.

### DETAILED DESCRIPTION

Equivalent parts are provided with the same reference signs in the figures.

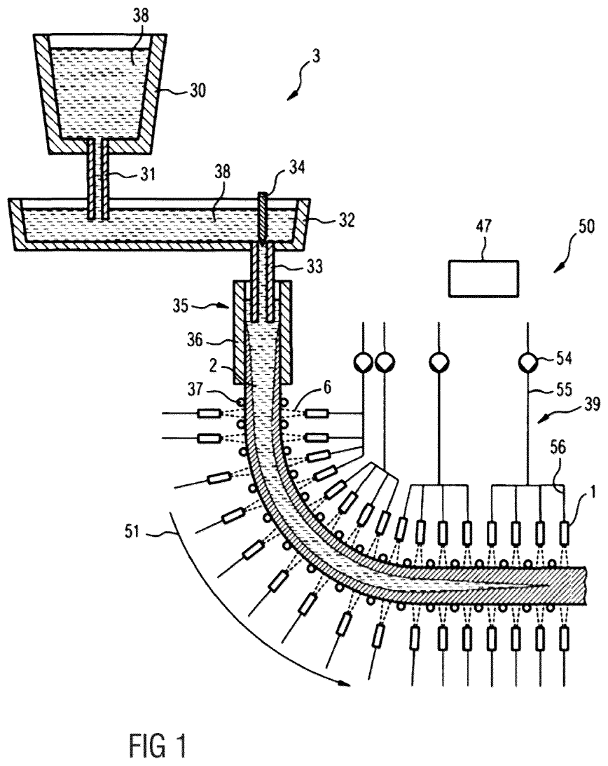

FIG. 1 (FIG. 1) shows a continuous casting installation 3 in a schematic illustration. The continuous casting installation 3 comprises, inter alia, a casting ladle 30 having an outlet pipe 31. The continuous casting installation 3 furthermore comprises a distribution trough 32 which is disposed below the casting ladle 30 and has a casting tube 33 and a plug 34. Moreover, the continuous casting installation 3 comprises a permanent mold 35 which has four water-cooled permanent mold plates 36 of copper and has a substantially rectangular cross-sectional shape. Only two of the four permanent mold plates 36 are visible in FIG. 1. Moreover, the continuous casting installation 3 comprises a plurality of driven transport rollers 37 which form elements of a strand guide of the continuous casting installation 3 for guiding and supporting a cast strand 2.

A liquid metallic melt 38 from the casting ladle 30 is directed into the distribution trough 32 by way of the outlet pipe 31. The melt 38 from the distribution trough 32 is directed into the permanent mold 35 by way of the casting tube 33, wherein a mass flow of the melt 38 flowing into the permanent mold 35 is controlled with the aid of the plug 34.

In the permanent mold 35, the melt 38 on the contact faces thereof contacting the water-cooled permanent mold plates 36 cools down and in the process solidifies on the contact faces in such a way that the melt 38 exits the permanent mold 35 in the form of a cast strand 2 having a rectangular cross section. When exiting the permanent mold 35, the cast strand 2 has a solidified strand shell, while the majority of the cross section of said cast strand 2 is still liquid. The cast strand 2 exiting the permanent mold 35 is conveyed away in a strand-conveying direction 51 with the aid of the transport rollers 37.

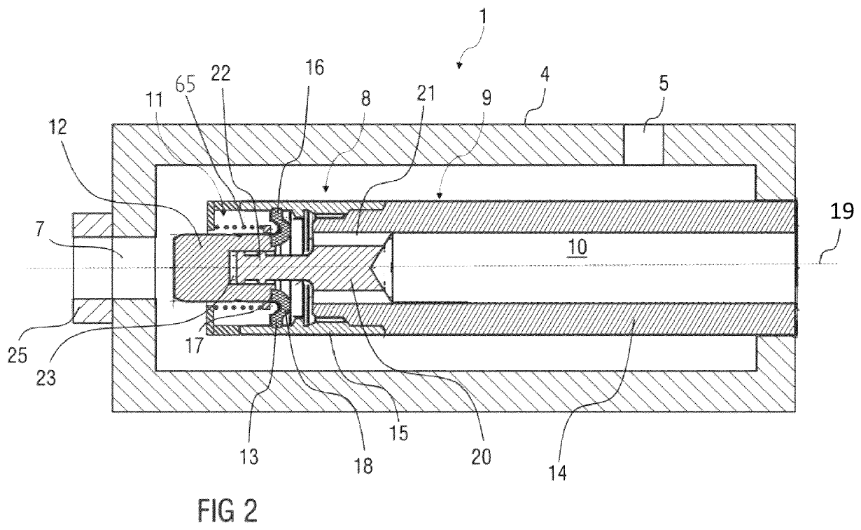

The continuous casting installation 3 furthermore has a cooling installation 50 for cooling the cast strand 2. The cooling installation 50 comprises a multiplicity of dispensing devices 1 according to the invention, which are in each case specified for intermittently dispensing a cooling medium 6 onto the cast strand 2. Exemplary embodiments of these dispensing devices 1 will be described in more detail hereunder by means of FIGS. 2 to 5. In the example shown in FIG. 1, the cooling installation 50 has a plurality of cooling zones 39 in which a plurality of dispensing devices 1 are in each case disposed, the cooling medium 6 being able to be supplied to the latter from a coolant pump 54 of the respective cooling zone 39 by way of a main coolant supply line 55 and cooling medium supply lines 56 that branch off from the main cooling medium supply line 55. The cooling installation 50 furthermore has a control unit 47 which is specified to control the dispensing devices 1.

FIG. 2 (FIG. 2) shows a sectional illustration of a first exemplary embodiment of a dispensing device 1 for intermittently dispensing the cooling medium 6 onto the cast strand 2. The dispensing device 1 comprises a housing 4 having at least one inlet opening 5 for admitting the cooling medium 6 into the housing 4, and a dispensing opening 7 for dispensing the cooling medium 6 from the housing 4. Furthermore, the dispensing device 1 comprises a switching valve 8 which is disposed in the housing 4 and is specified to open and close the dispensing opening 7.

The switching valve 8 has a sleeve 9 which is filled with a working fluid 10 and proximal to the dispensing opening is closed in a fluid-tight manner by a closure 11. The closure 11 comprises a switching element 12 and a rolling bellows 13. The rolling bellows 13 is an elastic sealing element which movably couples the switching element 12 to the sleeve 9.

The sleeve 9 is embodied in two parts, having a main part 14 and an end part 15. The end part 15 is attached to the main part 14 proximal to the dispensing opening, and is fixedly attached to said main part 14 and projects from the main part 14 in the direction toward the dispensing opening 7. The rolling bellows 13 has a first collar 16 which is fixedly connected to an inner surface of the end part 15, and a second collar 17 which is fixedly connected to the switching element 12. A rolling fold 18 of the rolling bellows 13 runs between the first collar 16 and the second collar 17.

The main part 14 is designed so as to be substantially tubular, having an end portion 20 proximal to the dispensing opening. The end portion 20 closes the main part 14 proximal to the dispensing opening, with the exception of ducts 21 that run through the end portion 20.

For guiding the switching element 12, the end portion 20 has a bar-type guiding element 22 which runs along a longitudinal axis 19 of the sleeve 9 and protrudes into a cutout 23 in the switching element 12 that corresponds to the guiding element 22. The guiding element 22 forms a dispensing opening-proximal end of the main part 14.

The switching element 12 is displaceable relative to the sleeve 9 by controlling a pressure in the working fluid 10. The pressure in the working fluid 10 is able to be controlled by the control unit 47. The pressure in the working fluid 10 is increased for closing the dispensing opening 7, so that the switching element 12 is displaced to the dispensing opening 7, and the dispensing opening 7 is closed by the switching element 12. The pressure in the working fluid 10 is reduced for opening the dispensing opening 7, so that the switching element 12 is displaced in the direction of the sleeve 9 by the pressure in the cooling medium 6, as a result of which the dispensing opening 7 is opened. This opening effect can additionally be facilitated by the spring element 65.

The dispensing device 1 furthermore has a nozzle 25 to which the cooling medium 6 to be dispensed is able to be supplied from the dispensing opening 7. The jet of the cooling medium 6 dispensed by the dispensing device 1 is shaped by the nozzle 25 which is only schematically illustrated in FIG. 1.

The working fluid 10 is a gas, for example air, or a liquid, for example an oil.

The rolling bellows 13 is made of an elastomer material, for example of a silicone or a rubber.

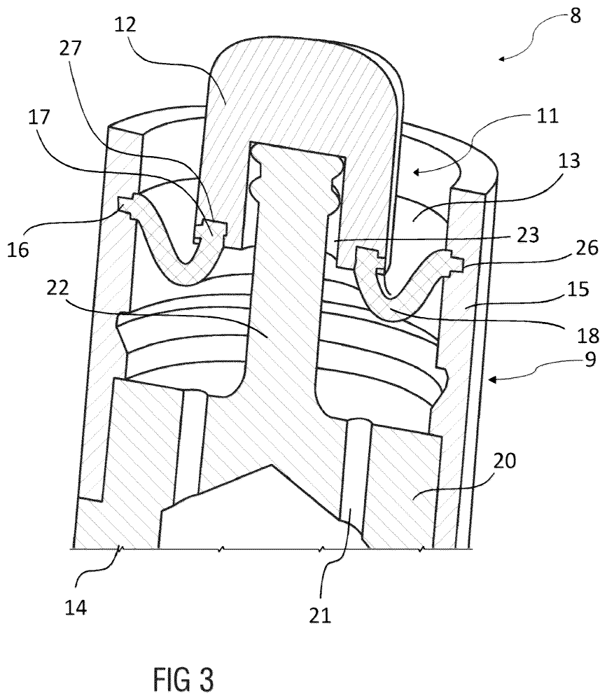

FIG. 3 (FIG. 3) shows a perspective illustration of the switching valve 8 of a second exemplary embodiment of a dispensing device 1 for intermittently dispensing the cooling medium 6 onto the cast strand 2. This exemplary embodiment of a dispensing device 1 differs from the exemplary embodiment shown in FIG. 2 substantially only in terms of the embodiment of the rolling bellows 13. Therefore, only the switching valve 8 in the region of the closure 11 of the sleeve 9 is shown in FIG. 3.

In the exemplary embodiment shown in FIG. 3, the first collar 16 of the rolling bellows 13 is fastened in an annular first groove 26 in the inner surface of the end piece 15 of the sleeve 9, and the second collar 17 of the rolling bellows 13 is fastened in an annular second groove 27 in an outer surface of the switching element 12 that faces away from the dispensing opening 7.

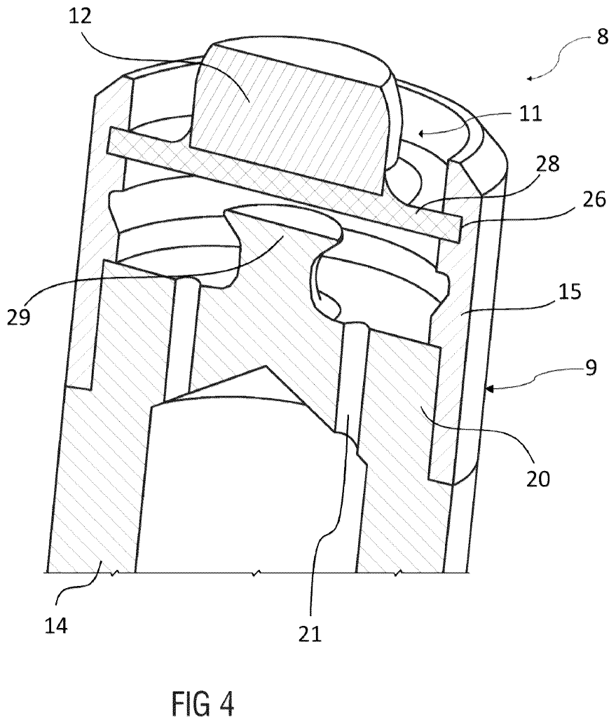

FIG. 4 (FIG. 4) shows a perspective illustration of the switching valve 8 of a third exemplary embodiment of a dispensing device 1 for intermittently dispensing the cooling medium 6 onto the cast strand 2. This exemplary embodiment of a dispensing device 1 differs from the exemplary embodiment shown in FIG. 2 in that the closure 11 of the sleeve 9 instead of the rolling bellows 13 has an elastic diaphragm 28 as the sealing element, the switching element 12 does not have a cutout 23, and the end portion 20 of the main part 14 of the sleeve 9 has a foot 29 instead of the guiding element 22. With the exception of these differences, the dispensing device 1 is designed like the dispensing device 1 shown in FIG. 2. Therefore, only the switching valve 8 of the dispensing device 1 in the region of the closure 11 of the sleeve 9 is shown, and only those features that differentiate the dispensing device 1 from the dispensing device 1 shown in FIG. 2 will be described hereunder.

The diaphragm 28 is made of an elastomer material, for example of a silicone or a rubber. The diaphragm 28 closes the sleeve 9 and is fastened in an annular groove 26 in the inner surface of the end piece 15 of the sleeve 9. The switching element 12 is fixedly disposed on the membrane 28 proximal to the dispensing opening.

The foot 29 forms the dispensing opening-proximal end of the main part 14 of the sleeve 9 and faces the diaphragm 28. The foot 29 prevents an excessive movement of the switching element 12 away from the dispensing opening 7, which could cause excessive elongation of the diaphragm 28.

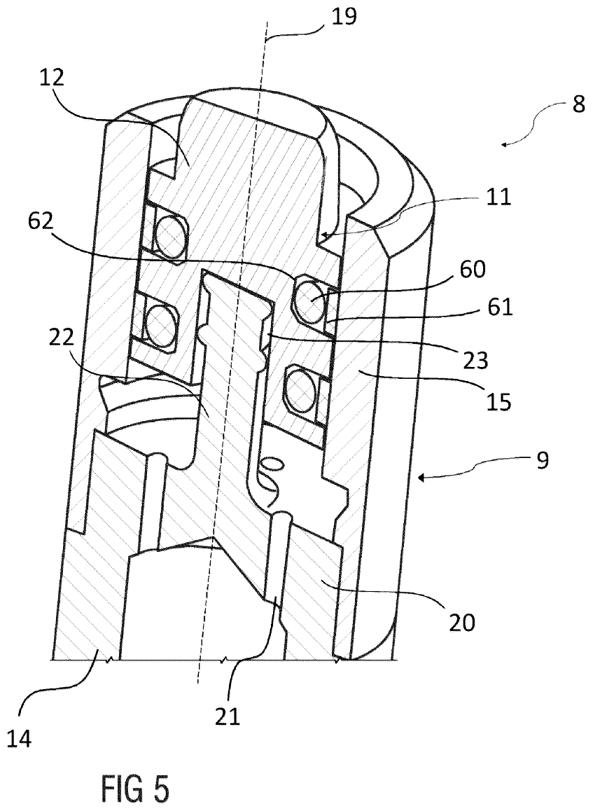

FIG. 5 (FIG. 5) shows a perspective illustration of the switching valve 8 of a fourth exemplary embodiment of a dispensing device 1 for intermittently dispensing the cooling medium 6 onto the cast strand 2. This exemplary embodiment of a dispensing device 1 differs from the exemplary embodiment shown in FIG. 2 substantially only in terms of the embodiment of the closure 11 of the sleeve 9. Therefore, only the switching valve 8 of the dispensing device 1 in the region of the closure 11 of the sleeve 9 is shown in FIG. 5, and only those features that differentiate the dispensing device 1 from the dispensing device 1 shown in FIG. 2 will be described hereunder.

The closure 11 comprises a switching element 12 which is movably mounted in the sleeve 9, and a plurality of annular seals 60, 61 which seal an intermediate space between the sleeve 9 and the switching element 12 in a fluid-tight manner. The annular seals 60, 61 are disposed in two grooves 62 which run in an annular manner about the longitudinal axis 19 of the sleeve 9 in an outer surface of the switching element 12 that faces the end part 15 of the sleeve 9.

A first annular seal 60 and a second annular seal 61 are disposed in each groove 62 herein. The first annular seal 60 rests on a groove base of the groove 62. The second annular seal 61 is disposed between the first annular seal 60 and the sleeve 9 and rests on the first annular seal 60 and on the end part 15 of the sleeve 9. The first annular seal 60 has an oval cross section. The second annular seal 61 has a substantially rectangular cross section.

The exemplary embodiment of a dispensing device 1 shown in FIG. 5 can be modified in different ways so as to form other exemplary embodiments. For example, the switching element 12 can have a different number of grooves 62 instead of two grooves 62. In particular, the switching element 12 can have only one groove 62. Alternatively or additionally, only one annular seal 60, 61 which rests on the groove base of the groove 62 and on the sleeve 9 can be disposed in one groove 62. Furthermore, at least one annular seal 60, 61 can be disposed in a groove which runs in the sleeve 9 instead of in the switching element 12. In particular, each annular seal 60, 61 can be disposed in a groove which runs in the sleeve 9.

While the invention has been illustrated and described in detail by preferred exemplary embodiments, the invention is not limited by the disclosed examples, and other variations can be derived therefrom by the person skilled in the art without departing the scope of protection of the invention.

### LIST OF REFERENCE SIGNS

1 Dispensing device
2 Cast strand
3 Continuous casting installation
4 Housing
5 Inlet opening
6 Cooling medium
7 Dispensing opening
8 Switching valve
9 Sleeve
10 Working fluid
11 Closure
12 Switching element
13 Rolling bellows
14 Main part
15 End part
16, 17 Collar
18 Rolling fold
19 Longitudinal axis
20 End portion
21 Duct
22 Guiding element
23 Cutout
25 Nozzle
26, 27 Groove
28 Diaphragm
29 Foot
30 Casting ladle
31 Outlet pipe
32 Distribution trough
33 Casting tube
34 Plug
35 Permanent mold
36 Permanent mold plate
37 Transport roller
38 Melt
39 Cooling cone
47 Control unit
50 Cooling installation
51 Strand-conveying direction
54 Coolant pump
55 Main cooling medium supply line
56 Cooling medium supply line
60, 61 Annular seal
62 Groove
65 Spring element

1. A dispensing device for intermittently dispensing a cooling medium onto a cast strand in a continuous casting installation, the dispensing device comprising:
a housing having at least one inlet opening for admitting the cooling medium into the housing, and a dispensing opening for dispensing the cooling medium from the housing; and
a switching valve which is disposed in the housing and is specified to open and close the dispensing opening;
wherein the switching valve has a sleeve which is filled with a working fluid and proximal to the dispensing opening is closed in a fluid-tight manner by a closure; wherein
the closure has a switching element, which is movably mounted in the sleeve and at least one sliding sealing element, which is disposed on the switching element or the sleeve and seals an intermediate space between the sleeve and the switching element; and
the switching element, by controlling a pressure in the working fluid, is displaceable relative to the sleeve to a closing position in which the switching element closes the dispensing opening.

2. (canceled)

3. (canceled)

4. (canceled)

5. (canceled)

6. (canceled)

7. The dispensing device as claimed in claim 1, wherein the sleeve for guiding the switching element has a bar-type guiding element which runs along the longitudinal axis of said sleeve and protrudes into a cutout in the switching element that corresponds to the guiding element.

8. The dispensing device as claimed in claim 1, having a nozzle to which the cooling medium to be dispensed is able to be supplied from the dispensing opening.

9. The dispensing device as claimed in claim 1, wherein the housing and the sleeve are disposed so as to be concentric.

10. The dispensing device as claimed in claim 1, wherein the working fluid is a gas.

11. The dispensing device as claimed in claim 1, wherein the working fluid is a liquid.

12. The dispensing device as claimed in claim 1, wherein a spring element is disposed in such a manner that the switching element is moved from the closing position to an opening position by the spring element.

13. A cooling installation for cooling a cast strand in a continuous casting installation, having a plurality of dispensing devices as claimed in claim 1.

14. The cooling installation as claimed in claim 13, having a control unit which is specified to control the pressure in the working fluid in the dispensing devices.

15. The dispensing device as claimed in claim 1, wherein the at least one sliding sealing element is an annular seal.
